(19) United States
(12) Patent Application Publication
(10) Pub. No.: US 2018/0351184 A1
(43) Pub. Date: Dec. 6, 2018

(54) FUEL CELL, CONTROL METHOD FOR FUEL CELL, AND COMPUTER READABLE RECORDING MEDIUM

(71) Applicant: BROTHER KOGYO KABUSHIKI KAISHA, Nagoya-shi (JP)

(72) Inventor: Yoshiaki FUKATSU, Nagoya-shi (JP)

(21) Appl. No.: 16/059,628

(22) Filed: Aug. 9, 2018

Related U.S. Application Data
(63) Continuation of application No. PCT/JP2017/001184, filed on Jan. 16, 2017.

(30) Foreign Application Priority Data
Mar. 25, 2016 (JP) 2016-062300

(51) Int. Cl. H01M 8/04119; H01M 8/04303; H01M 8/0438; H01M 8/04225; H01M 8/04746; H01M 8/04828; H01M 8/04007

(52) U.S. Cl. CPC H01M 8/04179; H01M 8/04303; H01M 8/04395; H01M 8/04074; H01M 8/04432; H01M 8/04753; H01M 8/04828; H01M 8/04225

(57) ABSTRACT

Provided are: a fuel cell capable of suppressing water remaining inside a gas-liquid separator at the time when power generation is stopped to prevent the water from being frozen, favorably draining water at the next power generation and preventing lowering in the function of the fuel cell; a control method for a fuel cell; and a recording medium recording a computer program so as to allow a computer to read the program.

The fuel cell includes a stack, a hydrogen supply unit, an on-off valve for supplying hydrogen, a hydrogen circulation passage returning gas exhausted from the stack to circulate the gas, the first pressure sensordetecting pressure in the hydrogen circulation passage, a gas-liquid separator separating water from the gas, a drain valve discharging water from the gas-liquid separator, and a control unit controlling opening and closing of an on-off valve and a drain valve.

The control unit controls opening and closing of the on-off valve and the drain valve based on the capacity of the hydrogen circulation passage, the capacity of the gas-liquid separator and the pressure detected by the first pressure sensor, to perform drain control processing.

### CROSS-REFERENCE TO RELATED APPLICATIONS

The present application is a continuation application of International Application No. PCT/JP2017/001184, filed on Jan. 16, 2017, which claims priority to Japanese Patent Application No. 2016-062300, filed on Mar. 25, 2016. The contents of these applications are incorporated herein by reference in their entirety.

### FIELD

The present disclosure relates to: a fuel cell provided with a power generation unit configured to generate electricity by reacting hydrogen and oxygen, a drain valve for discharging water emitted from the power generation unit to the outside, and a control unit configured to control opening and closing of the drain valve; a control method for a fuel cell; and a non-transitory computer readable recording medium recording a computer program for causing a computer to execute drain control processing.

### BACKGROUND

Examples of a battery cell which obtains electromotive force by sending hydrogen to a negative electrode include a fuel cell, a nickel-hydrogen cell and the like.

Since a fuel cell is a clean power generator having high power generation efficiency that may serve to construct a cogeneration system without being affected by the magnitude of the load, it has been considered to employ a fuel cell for various purposes including digital household electric appliances such as a personal computer and a portable telephone, an electric vehicle, a railroad, a base station of a portable telephone, a power plant and so forth.

A fuel cell includes a stack, multiple hydrogen cylinders, a hydrogen circulation passage and a hydrogen supply passage.

The stack is obtained by sandwiching a solid polymer electrolyte membrane between a negative electrode and a positive electrode from both sides so as to form a membrane electrode assembly, locating a pair of separators on both sides of the membrane electrode assembly so as to compose a plate-like unit cell, and laminating and packaging a plurality of such unit cells.

One end of the hydrogen supply passage is connected with the hydrogen cylinder via a regulator and an on-off valve. Hydrogen flows from the hydrogen cylinder through the hydrogen supply passage, passes through the part of the hydrogen circulation passage that is close to the negative electrode of the stack to be sent out to a portion on the negative electrode side within the stack, and flows through a flow passage in the portion. Exhaust gas (off gas) containing unreacted hydrogen, which has flown through the flow passage and is discharged from the stack, flows through the hydrogen circulation passage and is returned to the stack.

When hydrogen is supplied to the stack so that fuel gas containing hydrogen comes into contact with the negative electrode and oxidation gas containing oxygen such as air comes into contact with the positive electrode, an electrochemical reaction occurs on both of the electrodes and electromotive force is generated. Water is generated on the positive electrode side at the time of reaction, which is reversely diffused as water vapor to the negative electrode side through an electrolyte membrane. The water vapor or water condensed by a temperature difference is included in the off gas.

Since the off gas contains moisture as described above, a gas-liquid separator is located in the hydrogen circulation passage to separate gas from water, returning the gas to the power generation unit while discharging retained water at appropriate timings.

In the case where the power generation of the fuel cell is stopped, water remains in the gas-liquid separator while the water is frozen under the sub-zero environment. This prevents the water from draining at the next power generation. The fuel cell will thus be in a flooding state where the water overflows to block the hydrogen circulation passage, which reduces the function thereof.

It is therefore necessary to prevent water from remaining inside the gas-liquid separator and being frozen at the time when the power generation of the fuel cell is stopped.

Japanese Patent Application Laid-Open Publication No. 2002-313403 discloses the invention of a fuel cell configured to guide and store water generated by power generation to a storage unit located at a lower part of the hydrogen circulation passage and to store the water therein, to detect the level of water in the storage unit by a water level sensor, and to discharge the generated water in the storage unit from the lower part if the water level exceeds the upper limit set in advance.

### SUMMARY

In the case where the water level sensor is used to monitor the water level to drain the water as in the fuel cell according to Japanese Patent Application Laid-Open Publication No. 2002-313403, the water may be drained when the water level is at a position that is detectable by the water level sensor, while it is impossible to drain all the water stored in the gas-liquid separator if the water level is at a position that is not detectable by the water level sensor. If any water remains in the gas-liquid separator, it will be frozen under the sub-zero environment as described above.

The present invention has been made in view of the circumstances described above, and aims to provide: a fuel cell capable of suppressing water remaining inside a gas-liquid separator at the time when power generation is stopped to prevent the water from being frozen, favorably draining water at the next power generation and preventing lowering in the function of the fuel cell; a control method for a fuel cell; and a recording medium recording a computer program so as to allow a computer to read the program.

In a fuel cell according to the present disclosure provided with: a power generation unit configured to generate electricity by reacting hydrogen and oxygen; a fuel unit configured to supply hydrogen to the power generation unit; an on-off valve for supplying the hydrogen; a hydrogen circulation passage configured to return gas exhausted from the power generation unit to the power generation unit and circulate the gas; a pressure detector configured to detect pressure in the hydrogen circulation passage; a gas-liquid separator located at the hydrogen circulation passage to separate water from the gas; a drain valve configured to discharge water from the gas-liquid separator; and a control unit configured to control opening and closing of the on-off valve and the drain valve, the control unit controls opening and closing of the on-off valve and the drain valve to perform drain processing based on the capacity of the hydrogen circulation passage, the capacity of the gas-liquid separator and the pressure detected by the pressure detector.

A control method according to the present disclosure for a fuel cell configured to supply hydrogen from a fuel unit to a power generation unit by opening an on-off valve, to return gas exhausted from the power generation unit to the power generation unit through a hydrogen circulation passage and circulate the gas, and to separate water from the gas by a gas-liquid separator located at the hydrogen circulation passage to drain the water by a drain valve, comprises: obtaining pressure in the hydrogen circulation passage; and controlling opening and closing of the on-off valve and the drain valve based on the capacity of the hydrogen circulation passage, the pressure and the capacity of the gas-liquid separator, to drain water.

A non-transitory computer readable recording medium according to the present disclosure records a computer program causing a computer controlling a fuel cell provided with a hydrogen circulation passage configured to return gas exhausted from a power generation unit to circulate the gas, and a gas-liquid separator configured to separate water from the gas to drain the water, to execute processing of: obtaining pressure in the hydrogen circulation passage; calculating the number of times water is drained based on the capacity of the hydrogen circulation passage, the pressure and the capacity of the gas-liquid separator; and outputting an on-off signal for an on-off valve for supplying hydrogen and an on-off signal for a drain valve in accordance with the number of times obtained by calculating.

According to the present disclosure, the drain processing is performed by pushing out and discharging water stored in the gas-liquid separator based on the increased amount of gas inside the hydrogen circulation passage due to the difference in pressure obtained when the on-off valve is closed while the drain valve is opened from the state where the on-off valve is opened and the drain valve is closed, and on the capacity of the gas-liquid separator, to suppress the water remaining inside the gas-liquid separator and to prevent the water from being frozen. Therefore, water may favorably be drained at the next power generation, which prevents lowering in the function of the fuel cell.

In the drain processing, water is drained while the on-off valve is closed, which prevents leakage of hydrogen of a prescribed amount or larger even if the drain valve has a failure.

The above and further objects and features will more fully be apparent from the following detailed description with accompanying drawings.

### BRIEF DESCRIPTION OF THE DRAWINGS

FIG.1 is a block diagram illustrating a fuel cell according to Embodiment 1;

FIG. 2 is a flowchart illustrating drain control processing performed by a CPU;

FIG. 3 is a schematic section view of a gas-liquid separator;

FIG. 4A is a schematic section view of a gas-liquid separator;

FIG. 4B is a schematic section view of a gas-liquid separator;

FIG. 5 is a schematic section view of a gas-liquid separator according to Embodiment 2;

FIG. 6 is a flowchart illustrating the procedure of drain control processing performed by a CPU; and

FIG. 7 is a flowchart illustrating drain control processing performed by a CPU.

### DETAILED DESCRIPTION

The present disclosure will specifically be described below with reference to the drawings illustrating the embodiments thereof.

### Embodiment 1

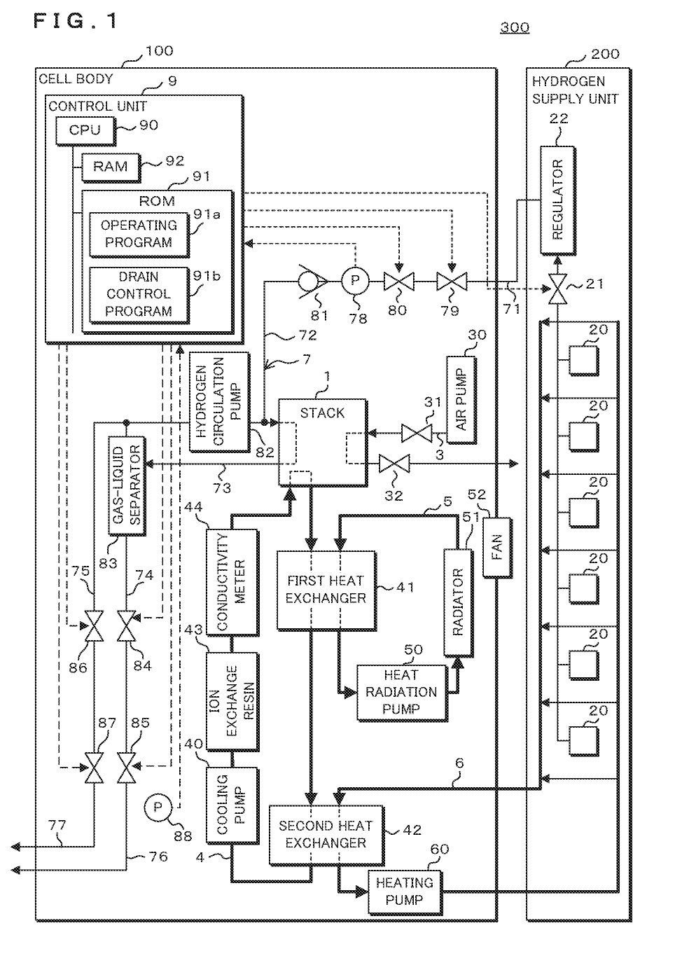

FIG. 1 is a block diagram illustrating a fuel cell 300 according to Embodiment 1.

The fuel cell 300 is provided with a cell body 100 and a hydrogen supply unit 200. The cell body 100 is a cell body such as a solid polymer electrolyte fuel cell, for example.

The cell body 100 is provided with a stack 1, an air flow passage 3, an air pump 30, a stack cooling passage 4, a cooling pump 40, a first heat exchanger 41, a second heat exchanger 42, a radiator flow passage 5, a heat radiation pump 50, a radiator 51, a fan 52, a cylinder heating passage 6, a heating pump 60, a hydrogen flow passage 7, a first pressure sensor 78, on-off valves 79 and 80, a hydrogen circulation pump 82, a gas-liquid separator 83, drain valves 84 and 85, exhaust valves 86 and 87, a second pressure sensor 88 and a control unit 9. The second heat exchanger 42 is provided with a heater (not illustrated).

The hydrogen supply unit 200 is provided with a plurality of metal hydride (MH) cylinders 20, an on-off valve 21 and a regulator 22. Each MH cylinder 20 is filled with a hydrogen storage alloy. The on-off valve 21 is connected with all MH cylinders 20 and is also connected with the regulator 22. The supply pressure of hydrogen is adjusted by the regulator 22. A reaction occurred when the hydrogen storage alloy in the MH cylinders 20 releases hydrogen is an endothermic reaction.

The stack 1 is obtained by sandwiching a solid polymer electrolyte membrane between a negative electrode and a positive electrode from both sides so as to form a membrane electrode assembly, locating a pair of separators on both sides of the membrane electrode assembly so as to compose a plate-like unit cell, and laminating and packaging a plurality of such unit cells.

When fuel gas containing hydrogen, which has flown in from the hydrogen supply unit 200, comes into contact with the negative electrode and oxidation gas containing oxygen such as air flows in from the air flow passage 3 and comes into contact with the positive electrode, an electrochemical reaction occurs on both electrodes and electromotive force is generated.

The hydrogen supply passage 7 is constituted by a hydrogen supply passage 71, a hydrogen introduction passage 72, a hydrogen circuit 73, a first drainage 74 and a first exhaust passage 75. The hydrogen introduction passage 72, hydrogen circuit 73 and first exhaust passage 75 constitute a hydrogen circulation passage. One end of the hydrogen supply passage 71 is connected with the regulator 22, while the other end thereof is connected in series with on-off valves 79 and 80. One end of the hydrogen introduction passage 72 is connected with the on-off valve 80, and the other end thereof is connected with a part, which is close to the negative electrode of the stack 1, of the hydrogen circuit 73. The hydrogen introduction passage 72 is provided with a first pressure sensor 78 and a check valve 81.

The hydrogen circuit 73 is provided with a hydrogen circulation pump 82 and a gas-liquid separator 83. The fuel cell 300 is constructed in such a manner that, when the on-off valves 21, 79 and 80 are opened, hydrogen flows through the hydrogen supply passage 71 and the hydrogen introduction passage 72, is pumped by the hydrogen circulation pump 82 to flow through the hydrogen circuit 73, and is sent out to a part on the negative electrode side of the stack 1 to flow through a flow passage in this part. Hydrogen, impurities (including impurities originally contained in hydrogen as well as impurities generated by reaction) and moisture, which are discharged from the stack 1, flow through the hydrogen circuit 73 and are sent to the gas-liquid separator 83.

In the gas-liquid separator 83, the hydrogen and the like are separated into water and gas containing hydrogen and impurities.

The first drainage 74 is connected with the lower side of the gas-liquid separator 83, and is provided with the drain valves 84 and 85, which are electromagnetic valves, arranged in series. The second drainage 76 is connected with the drain valve 85.

The first exhaust passage 75 is branched at the upper side of the gas-liquid separator 83 to extend from the hydrogen circuit 73, and is provided with exhaust valves 86 and 87 arranged in series for discharging the gas. The gas flows through the second exhaust passage 77 by energizing and opening the exhaust valves 86 and 87 at a predetermined timing, and is discharged to the outside.

At the gas-liquid separator 83, when the discharge valves 86 and 87 are closed, the separated gas flows from the gas-liquid separator 83 through the hydrogen circuit 73 to be sent to the hydrogen circulation pump 82 and returns to the stack 1.

The water obtained by separation at the gas-liquid separator 83 is stored and, the discharge valves 84 and 85 are energized and opened by drain control processing described later, so that the water flows through the first drainage 74 and the second drainage 76, and is discharged to the outside.

The second pressure sensor 88 is provided at the lower part of the gas-liquid separator 83.

It is also possible to cover the drain valves 84 and 85, the exhaust valves 86 and 87, the first drainage 74 as well as the first exhaust passage 75 with a heat insulating material.

The air pump 30 is provided at the air flow passage 3. In addition, an on-off valve 31 is provided at an inlet side part of the air flow passage 3 to the stack 1, and an on-off valve 32 is provided at an outlet side part thereof from the stack 1. The fuel cell 300 is constructed in such a manner that, when the on-off valve 31 and the on-off valve 32 are opened, air sent out from the air pump 30 flows through the air flow passage 3, is introduced into a positive electrode side part of the stack 1, and flows through a flow passage of this part. Air, which has flown through the flow passage, is discharged from the stack 1, and is discharged through the on-off valve 32 to the outside.

A cooling pump 40, an ion exchange resin 43 and a conductivity meter 44 are provided at the stack cooling passage 4. The fuel cell 300 is constructed in a such manner that cooling water, which is sent out from the cooling pump 40 and flows through the stack cooling passage 4, flows through the ion exchange resin 43, the conductivity of the cooling water is measured by the conductivity meter 44, and the cooling water is then introduced into the stack 1, flows through a flow passage in the stack 1, is then discharged, flows through the first heat exchanger 41 and the second heat exchanger 42, and returns to the cooling pump 40.

The heat radiation pump 50 is provided at the radiator flow passage 5. The fuel cell 300 is constructed in such a manner that heat radiation liquid such as antifreeze liquid sent out from the heat radiation pump 50 flows through the radiator 51, further flows through the first heat exchanger 41, and then returns to the heat radiation pump 50. The fan 52 is provided in proximity to the radiator 51.

The heating pump 60 is provided at the cylinder heating passage 6. The fuel cell 300 is constructed in such a manner that heating liquid sent out from the heating pump 60 flows through a flow passage in the hydrogen supply unit 200 while heating each MH cylinder 20, is then discharged from the hydrogen supply unit 200, flows through the second heat exchanger 42, and returns to the heating pump 60. Hydrogen is released from the hydrogen storage alloy in each MH cylinder 20 by heating. An example of heating liquid is antifreeze liquid.

The stack cooling passage 4, the radiator flow passage 5, the cylinder heating passage 6, the first heat exchanger 41 and the second heat exchanger 42 are covered with heat insulating material. The portions covered with the heat insulating material is indicated by thick lines in FIG. 1. The heat insulating material makes it possible to restrict heat transfer to/from the outside and to easily control the heat quantity.

The control unit 9 is provided with a central processing unit (CPU) configured to control the operation of each component in the control unit 9. The CPU 90 is connected with a ROM 91 and a RAM 92 via a bus.

The ROM 91 is a nonvolatile memory such as an electrically erasable programmable read-only memory (EEPROM), which stores an operating program 91a for the fuel cell 300 as well as a drain control program 91b according to the present embodiment.

Moreover, the drain control program 91b may be recorded on a recording medium such as a CD (Compact Disc)-ROM, which is a portable medium for computer-readable recording, a DVD (Digital Versatile Disc)-ROM, a BD (Blu-ray (registered trademark) Disc), a hard disk drive or a solid-state drive, so that the CPU 90 may read out the drain control program 91b from the recording medium and store the drain control program 91b in the ROM 91.

Furthermore, the drain control program 91b according to the present disclosure may also be acquired from an external computer (not illustrated) that is connected with a communication network, and be stored in the ROM 91.

The RAM 92 is a memory such as a DRAM (Dynamic RAM) or an SRAM (Static RAM), and temporarily stores the operating program 91a as well as the drain control program 91b that are read out from the ROM 91 in the process of execution of arithmetic processing by the CPU 90, and various data that are generated in arithmetic processing performed by the CPU 90.

The control unit 9 is connected with the respective components of the cell body 100 and with the on-off valve 21 of the hydrogen supply unit 200, to control the operations of the respective components and the on-off valve 21. Moreover, the control unit 9 is connected with the first pressure sensor 78 and the second pressure sensor 88. In FIG. 1, as for the connection between the control unit 9 and the components, only the portions necessary for the description of the present embodiment are illustrated.

A reaction occurring at the stack 1 is an exothermic reaction, and the stack 1 is cooled by cooling water, which flows through the stack cooling passage 4. Heat of cooling water, which has been discharged from the stack 1, is conducted to heat radiation liquid at the first heat exchanger 41, the heat radiation liquid radiates heat at the radiator 51, and the heat is radiated to the outside of the cell body 100 by the fan 52. Heat radiation liquid, which has been cooled at the radiator 51, is sent to the first heat exchanger 41.

Heat of cooling water, which has flown through the first heat exchanger 41 and has been introduced into the second heat exchanger 42 in the stack cooling passage 4, is conducted to heating liquid at the second heat exchanger 42, and the heating liquid heats each MH cylinder 20 of the hydrogen supply unit 200, and releases hydrogen from the hydrogen storage alloy.

Cooling water, which has been cooled at the second heat exchanger 42, returns to the cooling pump 40 and is sent to the stack 1.

While the temperature of cooling water in the stack cooing passage 4 depends on the environmental temperature when power is not being generated, it is possible to maintain each MH cylinder 20 at a predetermined temperature by heating the heating liquid with the heater of the second heat exchanger 42.

It is also possible to send air, which has heat generated at the stack 1, to the hydrogen supply unit 200 so as to heat each MH cylinder 20, without providing the cylinder heating passage 6. Furthermore, a heater may be provided in each MH cylinder 20 so as to directly heat the MH cylinder 20 with the heater.

In the present embodiment, after power generation is finished, the CPU 90 of the control unit 9 reads out the drain control program 91b from the ROM 91, and executes drain control processing for the gas-liquid separator 83.

The drain control processing will now be described below.

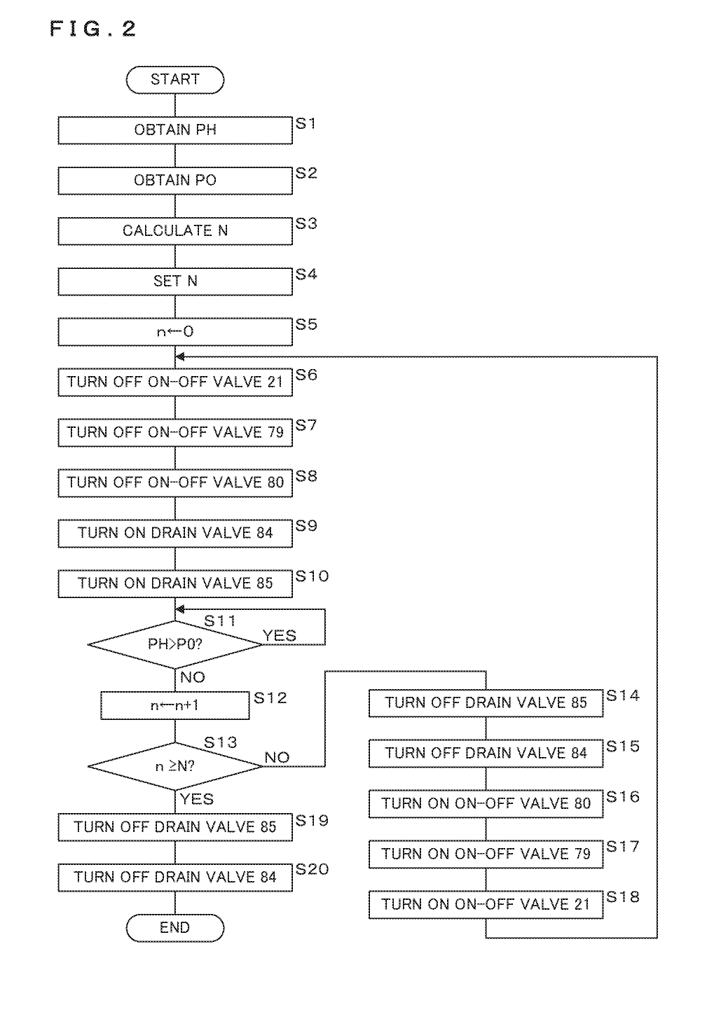

FIG. 2 is a flowchart illustrating drain control processing performed by the CPU 90.

The initial condition is where electricity is being generated at the cell body 100, the on-off valves 21, 79 and 80 are in the state of energization on (open) and the drain valves 84 and 85 are in the state of energization off (closed).

From this state, the CPU 90 stops generating power, and starts the drain control processing.

First, the CPU 90 obtains PH from the first pressure sensor 78 (S1), and obtains PO from the second pressure sensor 88 (S2). Here, PH is the pressure in the hydrogen circulation passage whereas PO is outside pressure.

The CPU 90 calculates the number of times (hereinafter referred to as set number)N set for discharge (S3).

Calculation methods for the set number N will be described below. The calculation methods include four methods (calculation methods 1 to 4). The set number N may be obtained using any one of these calculation methods. As will be described later in detail, the calculation methods 2 and 4 are to calculate the set number N while including the capacity of the first drainage 74 in the capacity of the hydrogen circulation passage. Moreover, in the case of using the calculation methods 3 and 4, it is necessary to have a configuration where the gas-liquid separator 83 is provided with a liquid level sensor 89.

Calculation Method 1

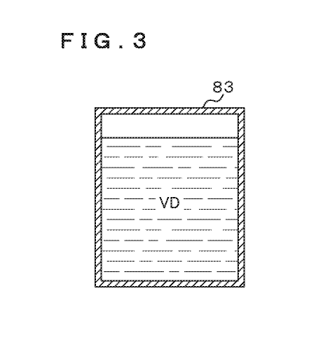

FIG. 3 is a schematic section view of a gas-liquid separator 83.

The capacity of the gas-liquid separator 83 when filled with water is assumed as VD (cc).

Assuming that the capacity of the hydrogen circulation passage described above is VH (cc), the pressure in the hydrogen circulation passage is PH (kPa), the outside pressure is PO (kPa), and the amount of the volume of gas when the pressure in the hydrogen circulation passage is changed from PH to PO (amount of discharge of water to be pushed out at a time) in the state where the on-off valves 21, 79 and 80 are closed is VA (cc),

PH×VH=PO×(VH+VA)

Therefore, VA={(PH−PO)/PO}×VH.

The volume of gas inside the gas-liquid separator 83 is increased by VA, and the water stored in the gas-liquid separator 83 is pushed out to be discharged.

Since water corresponding to the amount of VD is stored, the set number N for discharge to be required is obtained by the expression below.

N≥VD/VA

Calculation Method 2

In the calculation method 2, the set number N is calculated while including the capacity of the first drainage 74.

Here, it is assumed that the gas-liquid separator 83 is filled with water by the amount corresponding to the sum of the VD indicated above and the capacity VC (cc) of the first drainage 74, and the set number N is obtained by the expression below.

N≥(VD+VC)/VA

Calculation Method 3

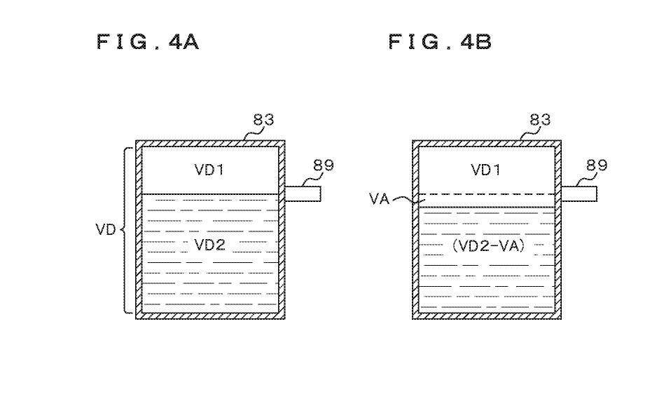

FIGS. 4A and 4B are schematic section views of the gas-liquid separator 83. The liquid level sensor 89 is provided at a predetermined position at an upper part of the gas-liquid separator 83. The liquid level sensor 89 detects the level of water in the gas-liquid separator 83. Though not illustrated in detail, the liquid level sensor 89 is connected with the control unit 9.

As illustrated in FIG. 4A, it is assumed that the entire capacity of the gas-liquid separator 83 is VD, the capacity of a portion of the gas-liquid separator 83 from the top surface to the liquid level sensor 89 (first capacity) is VD1, the capacity of a portion of the gas-liquid separator 83 from the liquid level sensor 89 to the bottom surface (second capacity) is VD2 (i.e., VD=VD1+VD2), and the water fills up to the liquid level sensor 89.

The pressure PH in the hydrogen circulation passage corresponds to the pressure of gas of the volume corresponding to the sum of the capacity VH of the hydrogen circulation passage and the first capacity VD1.

Thus, the amount of discharge VA at a time is obtained by the expression below.

VA={(PH−PO)/PO}×(VH+VD1)

Since the capacity of the gas-liquid separator 83 when filled with water is VD2, the set number N is obtained by the expression below.

N≥VD2/VA

As illustrated in FIG. 4B, the hydrogen circulation passage is opened to discharge water corresponding to the amount increased by the volume of VA.

Calculation Method 4

In the calculation method 4, the set number N is calculated while including the capacity of the first drainage 74.

As will be indicated below, VA obtained by the calculation method 3 described above is used to divide the sum of VD2 and VC, to obtain the set number N.

N≥(VD2+VC)/VA

The CPU 90 sets the set number N obtained by step S3 described above and stores it in the RAM 92 (S4), and resets the number of times the water is drained to “0” (S5).

The CPU 90 turns off the on-off valves 21, 79 and 80 in sequence (S6, S7, S8), turns on the drain valves 84 and 85 in sequence (S9, S10), to start draining.

The CPU 90 determines whether or not PH is larger than PO (S11). If it is determined that PH is larger than PO (S11: YES), the CPU 90 repeats the determination described above.

If it is determined that PH is not larger than PO (S11: NO), which means no draining is possible, the CPU 90 terminates the draining and increments the number of times n the water is drained by “1” (S12).

The CPU 90 determines whether or not the number of times n the water is drained is equal to or larger than the set number N (S13). If it is determined that the number of times n the water is drained is not equal to or larger than the set number N, the drain processing described above needs to be repeated.

If it is determined that the number of times n the water is drained is equal to or larger than the set number N (S13: NO), the CPU 90 turns off the drain valves 85 and 84 in sequence (S14, S15), turns on the on-off valves 80, 79 and 21 in sequence (S16, S17, S18), increases the pressure PH of the hydrogen circulation passage to the pressure value obtained at step S1, and returns the processing to step S6. Here, PH may be obtained from the pressure sensor 78 to confirm whether or not PH is increased to the pressure value, or time obtained from VH and the flow volume of hydrogen supplied from the hydrogen supply unit 200 may be used to confirm the increase in the pressure.

The CPU 90 repeats the drain processing described above until the number of times n the water is drained is equal to or larger than the set number N, and if it is determined at step S13 that n is equal to or larger than N (S13: YES), turns off the drain valves 85 and 84 in sequence (S19, S20), and terminates the drain control processing.

According to the present embodiment, drain control processing is repeated in which water stored in the gas-liquid separator 83 is pushed out and discharged, based on the increased amount of gas inside the hydrogen circulation passage due to the difference in pressure obtained when the on-off valves 21, 79 and 80 are closed while the drain valves 84 and 85 are opened from the state where the on-off valves 21, 79 and 80 are opened and the drain valves 84 and 85 are closed and the capacity of the gas-liquid separator 83, which may suppress the water remaining inside the gas-liquid separator 83 and prevent the water from being frozen.

More specifically, the amount VA of water to be discharged by the increase in the volume of gas by opening once is calculated from the ratio of the difference between the pressure PH of the hydrogen circulation passage and the outside pressure PO to PO as well as the capacity VH of the hydrogen circulation passage, and the set number (number of repetitions) N is calculated by dividing the capacity VD (or VD+VC) of the gas-liquid separator 83 by VA, so that the water remaining in the gas-liquid separator 83 is favorably suppressed.

Therefore, water may favorably be drained at the next power generation, which prevents lowering in the function of the fuel cell 300.

In the case where the water fills to the position of the liquid level sensor 89 at the time when power generation is stopped, that is, the case where the second capacity VD2, which corresponds to the difference between the entire capacity VD of the gas-liquid separator 83 and the first capacity VD1 to the position described above, is filled with water (FIG. 4A), the amount VA of water discharged at a time is calculated from the ratio of the difference between the pressure PH and the outside pressure PO to PO and the sum of VH and VD1, and the set number N is calculated by dividing the capacity VD of the gas-liquid separator 83 by VA, thereby favorably suppressing the water remaining in the gas-liquid separator 83.

Moreover, the set number N is calculated using the calculation method 2 or the calculation method 4 described above to execute drain control processing, which allows the water in the first drainage 74 to be drained in addition to the water in the gas-liquid separator 83, thereby also suppressing water remaining in the first drainage 74 and preventing the water from being frozen.

In the present embodiment, since the water is drained while the on-off valves 21, 79 and 80 are closed, leakage of hydrogen of a prescribed amount or larger may be prevented even if the drain valve 84 or 85 has a failure.

### Embodiment 2

A fuel cell according to Embodiment 2 has a configuration similar to the fuel cell 300 according to Embodiment 1 except for the configuration of the gas-liquid separator 83 and the procedure of drain processing.

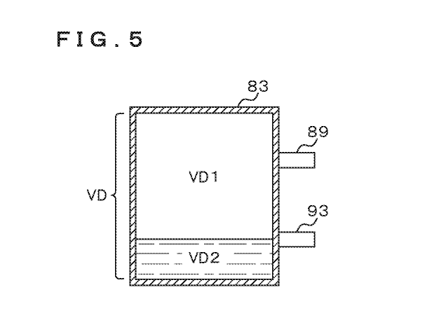

FIG. 5 is a schematic section view of a gas-liquid separator 83 according to Embodiment 2.

In the case where the level of stored water is located below the liquid level sensor 89 after power generation is stopped, it is difficult to accurately obtain the amount of water to be discharged.

In the gas-liquid separator 83 according to Embodiment 2, in addition to the liquid level sensor 89 located close to the top surface, a liquid level sensor 93 is provided close to the bottom surface. Similarly to the liquid level sensor 89, the liquid level sensor 93 is a sensor for detecting the level of water in the gas-liquid separator 83 and is connected with the control unit 9.

In Embodiment 2, after water is preliminarily drained until the level of the stored water reaches the position of the liquid level sensor 93, the set number N is obtained from the increased volume based on the pressure difference described above, to drain the water.

The set number N may be calculated as follows.

Calculation Method 5

As illustrated in FIG. 5, it is assumed that the entire capacity of the gas-liquid separator 83 is VD, the capacity of a portion of the gas-liquid separator 83 from the top surface to the liquid level sensor 93 (first capacity) is VD1, the capacity of a portion of the gas-liquid separator 83 from the liquid level sensor 93 to the bottom surface (second capacity) is VD2, and the water fills up to the liquid level sensor 93.

The pressure PH of the hydrogen circulation passage corresponds to the pressure of the gas of the volume corresponding to the sum of the capacity VH of the hydrogen circulation passage and the first capacity VD1.

The amount of discharge VA at a time may be obtained by the following expression.

VA={(PH+PO)/PO}×(VH+VD1)

Since the capacity of the gas-liquid separator 83 when filled with water is VD2, the set number N is obtained by the expression below.

N≥VD2/VA

Calculation Method 6

In Calculation Method 6, the set number N is calculated while including the capacity of the first drainage 74.

As indicated below, VA obtained by Calculation Method 5 described above is used to divide the sum of VD2 and VC, to obtain the set number N.

N≥(VD2+VC)/VA

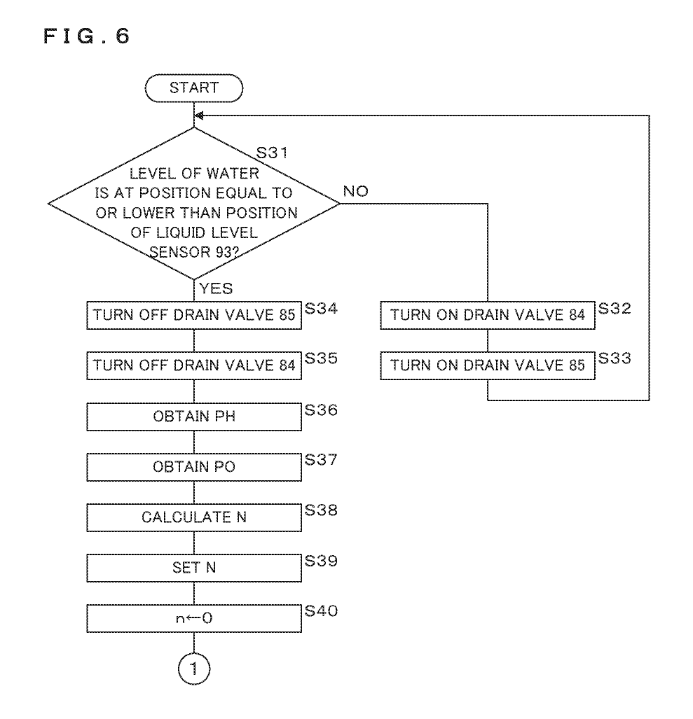

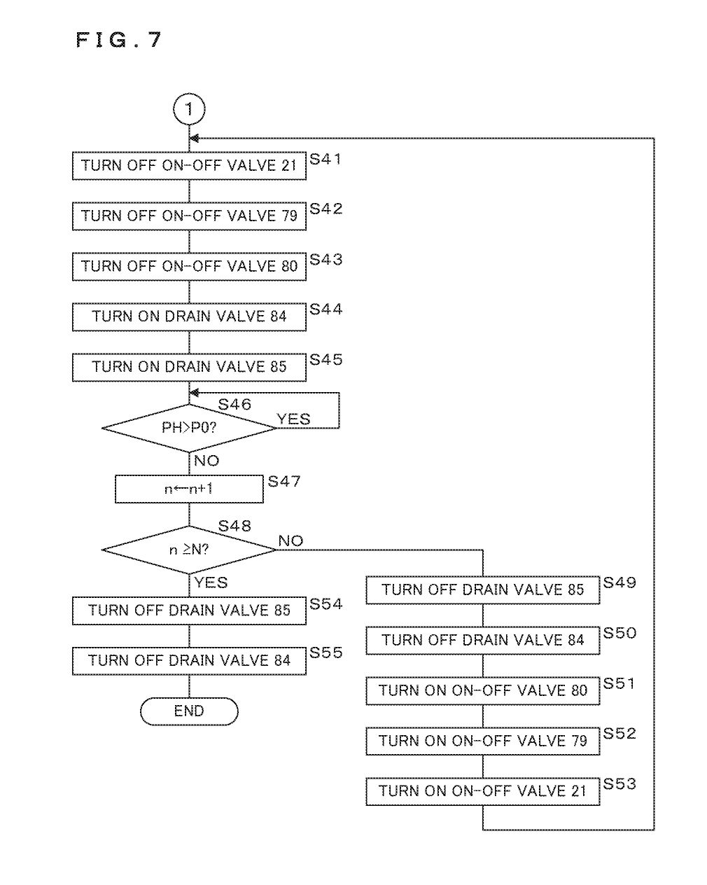

FIGS. 6 and 7 show a flowchart illustrating the procedure of drain control processing performed by the CPU 90.

The initial condition is where electricity is being generated at the cell body 100, the on-off valves 21, 79 and 80 are in the state of energization on (open) and the drain valves 84 and 85 are in the state of energization off (closed).

From this state, the CPU 90 stops generating power, and starts the drain control processing.

First, the CPU 90 determines whether or not the level of the water stored in the gas-liquid separator 83 is at a position equal to or lower than the position where the liquid level sensor 93 is installed (S31).

If it is determined that the water level is not at a position equal to or lower than the position of the liquid level sensor 93 (S31: NO), the CPU 90 turns on the drain valves 84 and 85 in sequence (S32, S33), preliminarily drains water until the water level reaches the position corresponding to the liquid level sensor 93, and returns the processing to step S31.

If the water level reaches the position of the liquid level sensor 93 as a result of the preliminary draining, the CPU 90 determines that the water level is at a position equal to or lower than the position of the liquid level sensor 93 (S31: YES), and turns off the drain valves 85 and 84 in sequence (S34, S35).

The CPU 90 obtains PH from the first pressure sensor 78 (S36), and obtains PO from the second pressure sensor 88 (S37).

The CPU 90 calculates the set number N as described above (S38).

The CPU 90 sets the set number N obtained by step S38 (S39), and resets the number of times n the water is drained to “0” (S40).

The CPU 90 turns off the on-off valves 21, 79 and 80 in sequence (S41, S42, S43) and turns on the drain valves 84 and 85 in sequence (S44, S45), to start draining.

The CPU 90 determines whether or not PH is larger than PO (S46). If it is determined that PH is larger than PO (S46: YES), the CPU 90 repeats the determination described above.

If it is determined that PH is not larger than PO (S46: NO), which means no draining is possible, the CPU 90 terminates the draining and increments the number of times n the water is drained by “1” (S47).

The CPU 90 determines whether or not the number of times n the water is drained is equal to or larger than the set number N (S48).

If it is determined that the number of times n the water is drained is not equal to or larger than the set number N (S48: NO), the CPU 90 turns off the drain valves 85 and 84 in sequence (S49, S50), turns on the on-off valves 80, 79 and 21 in sequence (S51, S52, S53), increases the pressure PH of the hydrogen circulation passage to the pressure value obtained at step 51, and returns the processing to step S41.

The CPU 90 repeats the drain control processing described above until the number of times n the water is drained is equal to or larger than the set number N, and if it is determined at step S48 that n≥N (S48: YES), turns off the drain valves 85 and 84 in sequence (S54, S55), and terminates the drain control processing.

In the present embodiment, after power generation is stopped, preliminary draining where the level of the stored water is lowered to the position of the liquid level sensor 93 is performed before the drain control processing, making it possible to accurately obtain the amount of water to be discharged. This can reduce the number of times the drain control processing is performed.

In a fuel cell according to the present disclosure configured as described above comprising: a power generation unit (stack) configured to generate electricity by reacting hydrogen and oxygen; a fuel unit (hydrogen supply unit) configured to supply hydrogen to the power generation unit; an on-off valve for supplying the hydrogen; a hydrogen circulation passage configured to return gas exhausted from the power generation unit to the power generation unit and circulate the gas; a pressure detector (pressure sensor) configured to detect the pressure in the hydrogen circulation passage; a gas-liquid separator located at the hydrogen circulation passage to separate water from the gas; a drain valve configured to discharge water from the gas-liquid separator; and a control unit configured to control opening and closing of the on-off valve and the drain valve, the control unit controls opening and closing of the on-off valve and the drain valve to perform drain processing (drain control processing) based on a capacity of the hydrogen circulation passage, a capacity of the gas-liquid separator, and the pressure detected by the pressure detector.

According to the present disclosure, drain processing is performed by pushing out and discharging water stored in the gas-liquid separator based on the increased amount of gas inside the hydrogen circulation passage due to the difference in pressure obtained when the on-off valve is closed while the drain valve is opened from the state where the on-off valve is opened and the drain valve is closed, and on the capacity of the gas-liquid separator, to suppress the water remaining inside the gas-liquid separator and to prevent the water from being frozen. Therefore, water may favorably be drained at the next power generation, which prevents lowering in the function of the fuel cell. Since the water is drained while the on-off valve is closed, leakage of hydrogen of a prescribed amount or larger may be prevented even if the drain valve has a failure.

In the fuel cell according to the present disclosure, the control unit calculates the number of times (set number) the drain processing is performed, based on the capacity of the hydrogen circulation passage, the capacity of the gas-liquid separator and the pressure detected by the pressure detector.

According to the present disclosure, the amount of water to be discharged due to increase of the volume of gas by opening the hydrogen circulation passage once is compared with the capacity of the gas-liquid separator to calculate the number of times the drain processing is performed, which may favorably suppress the water remaining inside the gas-liquid separator.

In the fuel cell according to the present disclosure, a water level detector is provided that detects the level of water stored in the gas-liquid separator, and the control unit calculates the number of times the drain processing is performed, based on the capacity of the hydrogen circulation passage, the entire capacity of the gas-liquid separator, the first capacity of the gas-liquid separator from the top surface to the predetermined water level and the pressure detected by the pressure detector.

According to the present disclosure, in the case where water is stored up to the position of the water level detector when power generation is stopped, that is, the case where the capacity of the gas-liquid separator corresponding to the difference between the entire capacity of the gas-liquid separator and the first capacity (second capacity) is filled with water, the second capacity is compared with the amount corresponding to the increased volume of the gas obtained by opening the hydrogen circulation passage once to calculate the number of times the discharge processing is performed, which may favorably suppress the water remaining inside the gas-liquid separator.

In the fuel cell according to the present disclosure, the control unit calculates the number of times the drain processing is performed by calculating the amount of water to be discharged at a time based on the difference between the pressure detected by the pressure detector and the outside pressure and on the sum of the first capacity and the capacity of the hydrogen circulation passage, and by dividing the difference between the entire capacity and the first capacity by the amount of water to be discharged at a time.

According to the present disclosure, the amount of water to be discharged at a time due to the increase of volume may accurately be calculated based on the sum of the first capacity and the capacity of the hydrogen circulation passage, that is, the volume up to the liquid level of water and the difference between the pressure in the gas-liquid separator and the outside pressure, so that the number of times the drain processing is performed may favorably be calculated.

In the fuel cell according to the present disclosure, a second pressure detector is provided that detects the outside pressure, and the control unit calculates the amount to be discharged based on the difference between the pressure described above and the outside pressure detected by the second pressure detector.

According to the present disclosure, the second pressure detector is provided, which may accurately calculate the amount to be discharged even if the fuel cell is located at a place where the outside pressure is not the standard pressure.

In the fuel cell according to the present disclosure, a drain pipe that connects the drain valve with the gas-liquid separator is provided, and the control unit calculates the number of times the drain processing is performed while including the capacity of the drain valve.

According to the present disclosure, the number of times the drain processing is performed is calculated while including the capacity of the drain pipe, which may prevent the water form remaining inside the drain pipe and being frozen.

In the fuel cell according to the present disclosure, the water level detector is located close to the bottom surface of the gas-liquid separator, and the control unit performs preliminary drain processing where the drain valve is opened until the water level detected by the water level detector reaches a predetermined water level.

In the present disclosure, after power generation is stopped, preliminary draining where the level of the stored water is lowered to a certain level is performed before the drain processing, making it possible to accurately obtain the amount of water to be discharged. This can reduce the number of times the drain processing is performed.

A control method according to the present disclosure for a fuel cell configured to supply hydrogen from a fuel unit to a power generation unit by opening an on-off valve, to return gas exhausted from the power generation unit to the power generation unit through a hydrogen circulation passage and circulates the gas, and to separate water from the gas by a gas-liquid separator located at the hydrogen circulation passage to drain the water by a drain valve, comprises: obtaining pressure in the hydrogen circulation passage; and controlling opening and closing of the on-off valve and the drain valve based on the capacity of the hydrogen circulation passage, the pressure and the capacity of the gas-liquid separator, to drain water.

According to the present disclosure, drain processing is performed by pushing out and discharging water stored in the gas-liquid separator based on the increased amount of gas inside the hydrogen circulation passage due to the difference in pressure obtained when the on-off valve is closed while the drain valve is opened to open the hydrogen circulation passage from the state where the on-off valve is opened and the drain valve is closed, and on the capacity of the gas-liquid separator, to suppress the water remaining inside the gas-liquid separator and to prevent the water from being frozen.

A non-transitory computer readable recording medium according to the present disclosure stores a computer program in such a manner that a computer is able to read the program, causing the computer controlling a fuel cell provided with a hydrogen circulation passage that returns gas exhausted from a power generation unit and circulates the gas, and a gas-liquid separator that separates water from the gas to drain the water, to execute processing of: obtaining pressure in the hydrogen circulation passage; calculating the number of times the drain processing is performed based on the capacity of the hydrogen circulation passage, the pressure and the capacity of the gas-liquid separator; and outputting an on-off signal for an on-off valve for supplying hydrogen and an on-off signal for a drain valve in accordance with the number of times obtained by calculating.

According to the present disclosure, the amount of water to be discharged due to the increase in the volume of gas by opening the hydrogen circulation passage once is compared with the capacity of the gas-liquid separator to calculate the number of times the drain processing is performed, which may favorably discharge the water inside the gas-liquid separator.

The present invention is not limited to the contents of Embodiments 1 and 2 described above, and various modifications can be made within the scope indicated by the appended claims. That is, embodiments to be obtained by combining technical measures obtained from suitable modifications within the scope indicated by the claims are also included in the technical scope of the present invention.

For example, the water level sensor provided at the gas-liquid separator 83 is not limited to a liquid level sensor but may also be a float sensor or the like.

Moreover, in the case where the outside pressure of the place where the fuel cell 300 is located may be the standard pressure, the set number N may be calculated assuming that PO is 101 kPa, without the second pressure sensor 88.

Furthermore, if the temperature varies, VA may be calculated using an equation of state for gases.

It is also possible to obtain PH to calculate VA every time water is drained without obtaining the set number N, and to terminate the drain control processing if the total amount of VA reaches an amount equal to or larger than a predetermined capacity of the gas-liquid separator 83.

It is to be noted that, as used herein and in the appended claims, the singular forms “a”, “an”, and “the” include plural referents unless the context clearly dictates otherwise.

What is claimed is:

1. A fuel cell comprising: a power generation unit configured to generate electricity by reacting hydrogen and oxygen; a fuel unit configured to supply hydrogen to the power generation unit; an on-off valve for supplying the hydrogen; a hydrogen circulation passage configured to return gas exhausted from the power generation unit to the power generation unit and circulate the gas; a pressure detector configured to detect pressure in the hydrogen circulation passage; a gas-liquid separator located at the hydrogen circulation passage to separate water from the gas; a drain valve configured to discharge water from the gas-liquid separator; and a control unit configured to control opening and closing of the on-off valve and the drain valve, wherein
the control unit controls opening and closing of the on-off valve and the drain valve to perform drain processing based on a capacity of the hydrogen circulation passage, a capacity of the gas-liquid separator, and the pressure detected by the pressure detector.

2. The fuel cell according to claim 1, wherein
the control unit calculates the number of times the drain processing is performed, based on the capacity of the hydrogen circulation passage, the capacity of the gas-liquid separator and the pressure detected by the pressure detector.

3. The fuel cell according to claim 2, comprising
a water level detector configured to detect a level of water stored in the gas-liquid separator,
wherein the control unit calculates the number of times the drain processing is performed, based on the capacity of the hydrogen circulation passage, an entire capacity of the gas-liquid separator, a first capacity of the gas-liquid separator from a top surface to a predetermined water level and the pressure detected by the pressure detector.

4. The fuel cell according to claim 3, wherein
the control unit calculates an amount of water to be discharged at a time based on a difference between the pressure detected by the pressure detector and outside pressure and on a sum of the first capacity and the capacity of the hydrogen circulation passage, and calculates the number of times the drain processing is performed by dividing a difference between the entire capacity and the first capacity by the amount of water to be discharged at a time.

5. The fuel cell according to claim 4, comprising
a second pressure detector configured to detect the outside pressure,
wherein the control unit calculates the amount to be discharged based on the difference between the pressure and the outside pressure detected by the second pressure detector.

6. The fuel cell according to claim 2, comprising
a drain pipe that connects the drain valve with the gas-liquid separator,
wherein the control unit calculates the number of times the drain processing is performed while including the capacity of the drain valve.

7. The fuel cell according to claim 3, comprising
a drain pipe that connects the drain valve with the gas-liquid separator,
wherein the control unit calculates the number of times the drain processing is performed while including the capacity of the drain valve.

8. The fuel cell according to claim 4, comprising
a drain pipe that connects the drain valve with the gas-liquid separator,
wherein the control unit calculates the number of times the drain processing is performed while including the capacity of the drain valve.

9. The fuel cell according to claim 5, comprising
a drain pipe that connects the drain valve with the gas-liquid separator,
wherein the control unit calculates the number of times the drain processing is performed while including the capacity of the drain valve.

10. The fuel cell according to claim 3, wherein
the water level detector is located close to a bottom surface of the gas-liquid separator, and
the control unit performs preliminary drain processing where the drain valve is opened until the water level detected by the water level detector reaches the predetermined water level.

11. The fuel cell according to claim 4, wherein
the water level detector is located close to a bottom surface of the gas-liquid separator, and
the control unit performs preliminary drain processing where the drain valve is opened until the water level detected by the water level detector reaches the predetermined water level.

12. The fuel cell according to claim 5, wherein
the water level detector is located close to a bottom surface of the gas-liquid separator, and
the control unit performs preliminary drain processing where the drain valve is opened until the water level detected by the water level detector reaches the predetermined water level.

13. The fuel cell according to claim 9, wherein
the water level detector is located close to a bottom surface of the gas-liquid separator, and
the control unit performs preliminary drain processing where the drain valve is opened until the water level detected by the water level detector reaches the predetermined water level.

14. A control method for a fuel cell configured to supply hydrogen from a fuel unit to a power generation unit by opening an on-off valve, to return gas exhausted from the power generation unit to the power generation unit through a hydrogen circulation passage and circulate the gas, and to separate water from the gas by a gas-liquid separator located at the hydrogen circulation passage to drain the water by a drain valve, comprising:
obtaining pressure in the hydrogen circulation passage; and
controlling opening and closing of the on-off valve and the drain valve based on the capacity of the hydrogen circulation passage, the pressure and the capacity of the gas-liquid separator, to drain water.

15. A non-transitory computer readable recording medium recording a computer program causing a computer controlling a fuel cell comprising a hydrogen circulation passage configured to return gas exhausted from a power generation unit to circulate the gas, and a gas-liquid separator configured to separate water from the gas to drain the water, to execute processing of:
obtaining pressure in the hydrogen circulation passage;
calculating the number of times water is drained based on a capacity of the hydrogen circulation passage, the pressure and a capacity of the gas-liquid separator; and
outputting an on-off signal for an on-off valve for supplying hydrogen and an on-off signal for a drain valve in accordance with the number of times obtained by calculating.
